(19) United States
(12) Patent Application Publication
(10) Pub. No.: US 2002/0193968 A1
(43) Pub. Date: Dec. 19, 2002

(54) Multifunction intelligent electronic device and method

(76) Inventors: Metaxas Gamvrelis, Calgary (CA); Sigismund Poda, Calgary (CA)

Correspondence Address: NIXON & VANDERHYE P.C., 8th Floor, 1100 North Glebe Road, Arlington, VA, 22201, US

(21) Appl. No.: 09/878,920

(22) Filed: Jun. 13, 2001

(51) Int. Cl. G06F 11/00; G06F 15/00

(52) U.S. Cl. 702/188

(57) ABSTRACT

A multifunction apparatus for monitoring and reporting electric signals on electric circuits is disclosed. The apparatus comprises a first system for receiving input data from at least a field transformer or a line post sensor; a digital signal processor (DSP) system coupled to the first system; a microprocessor system coupled to the DSP system. The first system in combination with the DSP system and the microprocessor system perform metering, power quality, digital fault recording (DFR) and supervisory control and data acquisition (SCADA) functions.

### FIELD OF THE INVENTION

This invention relates to a method and apparatus for monitoring electric signals on electric circuits and, more particularly, it relates to a multifunction intelligent electronic device (IED) for performing metering, power quality, digital fault recording (DFR), and supervisory control and data acquisition (SCADA) functions.

### BACKGROUND OF THE INVENTION

Electric power must be monitored and controlled to ensure proper operational performance. Power must be monitored and controlled in real-time to permit switching for maintenance, improved utilization and efficiency, and in response to situations that may compromise safety. Electric power must also be metered at various points for revenue purposes and also to ensure that circuits are optimally loaded. With the proliferation of computer equipment and electronic controllers for motor drives, electric circuits are littered with unwanted signals called “harmonics”. These harmonics contribute to reducing power quality and must, therefore, be identified and controlled to prevent equipment disturbances and failures. As these metered and harmonic signals are relatively small in magnitude, they must be reported with high precision within a range that is typically termed as the “nominal” range. Further, power lines are subjected to various disturbances as a result of natural and environmental effects such as lightning, high winds, ice load, rodents, birds, etc. Man made circumstances such as vehicular accidents further add to these disturbances.

In contrast to harmonic and metered signals, disturbance signals are usually large in magnitude and occur within a range that is typically termed as the “overcurrent” range. The “overcurrent” range spans from “1-42” times the “nominal range”. Signals in this range are typically recorded with a DFR system. Electric operators require equipment that can accurately, safely, and economically monitor and control power lines in real-time (i.e., via SCADA) in addition to recording and reporting both metering and disturbance information.

With respect to metering DFR and SCADA functions, known methods typically call for separate equipment units to carry out metering, harmonic spectrum and disturbance functions due to the inability of an integrated device to perform multiple functions in the required range of measurement. Prior methods accomplished utility metering and harmonic spectrum functions with metering devices, while disturbance recording functions were accomplished using a different apparatus such as a DFR system. SCADA was accomplished by interfacing the equipment to be monitored and controlled in real-time to remote terminal units (RTUs). These multiple devices interfaced to the power lines via potential transformers (PTs) and current transformers (CTs). Employing multiple devices to perform a plurality of functions requires more installation room and increased engineering, commissioning, and maintenance costs.

### BRIEF SUMMARY OF THE INVENTION

Accordingly, the exemplary apparatus described herein provides a multifunction intelligent electronic device (IED) and method for performing such functions as metering, power quality, digital fault recording (DFR) over an extended current range, while permitting real-time monitoring and control (SCADA) equipment, such as for example, communication devices, for multiple and primary equipment having a plurality of digital inputs, transducerless AC analog inputs to name a few. The IED may be directly connected to voltage potential and current transformers or line post sensors on electric circuits to monitor electric signals.

Input data from field transformers, such as current transformers (CTs) and potential transformers (PTs), is received by an A.C. input sub-system which is coupled to field transformers through a field interface terminal unit. The A.C. input subsystem is coupled to a digital signal processor (DSP) system to process the data received from the field transformers for executing metering, harmonic content, and DFR functions. The DSP subsystem converts the analog input signals into digital representations using a MUX/ A/D converter/ Signal conditioning unit. The DSP subsystem includes first and second signal processing devices which operate under the control of a primary microprocessor to control various functions of the IED apparatus including the switching functions of the A.C. subsystem in overcurrent and metering ranges. A second microprocessor works with the primary microprocessor that monitors and controls a plurality of input and output signals for SCADA functions.

Each transformer further includes normal and common mode surge and fast transient protection circuitry, and a crowbar protection circuit for protection against signals that are higher in positive polarity than a supply voltage +V, and signals that have more negative polarity than a supply voltage −V. Switching circuits of the IED perform appropriate auto-ranging functions depending on whether the field current in a primary circuit of a respective transformer is within a metering range or an overcurrent range. A microprocessor controls the functioning of each of the switching units in addition to providing such functions as analog-to-digital conversion, multiplexing functions, et cetera.

In one aspect, a multifunction apparatus for monitoring and reporting electric signals on electric circuits, comprising a first system for receiving input data from at least a field transformer or line post sensor; a digital signal processor (DSP) system coupled to the first system; a microprocessor system coupled to the DSP system; and the first system in combination with the DSP system and the microprocessor system perform metering, power quality, digital fault recording (DFR) and supervisory control and data acquisition (SCADA) functions. The first system comprises a plurality of transformers, each transformer operating with respect to one phase of an electric circuit; and a plurality of switching circuits, each circuit coupled to a respective transformer and further adapted to switch to multiple positions depending on whether the current flowing through a primary circuit of a respective transformer is in a metering range or an overcurrent range. The multifunction apparatus further comprises a circuit assembly for providing normal mode surge and fast transient protection. The circuit assembly preferably comprises a gas tube arrestor, a metal oxide varistor (MOV), a transient voltage suppressor, or a capacitor. The multifunction apparatus further comprises a circuit assembly for providing common mode surge and fast transient protection. A secondary circuit of each transformer preferably includes a diode mirror circuit for providing crowbar protection against signals that are higher in absolute value than supply voltage.

In another aspect, a method for monitoring electric signals on electric circuits, the method comprising electrically coupling a monitoring apparatus to a field sensor; feeding data from the field sensor to an A.C. subsystem of the monitoring apparatus, the A.C. sub-system comprising a plurality of transformers; and causing switching circuits to switch to multiple positions depending on whether current flowing through a primary circuit of a respective transformer is in a metering range or an overcurrent range. The method further comprises: providing a digital signal processor (DSP) sub-system to process data received by the A.C. sub-system; and providing one or more microprocessors for (a) controlling communication software applications of the apparatus, (b) performing supervisory control and data acquisition (SCADA) functions. The method further comprises providing normal mode surge and transient protection circuit between the field sensor and a primary circuit of each of the plurality of transformers; and controlling the A.C. sub-system and the DSP sub-system by at least one or more microprocessors. The method also comprises providing common mode surge and transient protection circuit between the field sensor and a primary circuit of each of the plurality of transformers, providing a crowbar protection circuit against signals that are higher in absolute value than supply voltage.

In another aspect, a multifunction apparatus for monitoring and reporting electric signals, comprising: a first subsystem receiving input data from at least one field sensor, the first subsystem having a plurality of transformers, one or more switching circuits, each switching circuit capable of switching to multiple positions depending on whether the current flowing in a primary circuit of a respective transformer is in a metering range or an overcurrent range; one or more digital signal processors processing data received by the first subsystem; and one or more microprocessors controlling the first subsystem and the one or more digital signal processors.

In yet another aspect, an apparatus for monitoring electric signals on electric circuits, the apparatus comprising: an A.C. sub-system having a plurality of transformers, and one or more switching circuits; means for electrically coupling the apparatus to a field sensor; means for feeding data from the field sensor to the A.C. subsystem; and means for causing the switching circuits to switch to multiple positions depending on whether the current flowing in a primary circuit of a respective transformer is in a metering range or an overcurrent range.

### BRIEF DESCRIPTION OF THE DRAWINGS

FIG. 1 shows an exemplary high level block diagram embodying the device in accordance with an example embodiment of the present invention;

FIG. 2 illustrates an exemplary detailed circuit diagram of the multifunction intelligent electronic device for measuring signals of a three-phase power line in accordance with an example embodiment of the present invention;

FIG. 3 illustrates an exemplary Digital Signal Processor (DSP) sub-system of the present invention of FIG. 1;

FIG. 4 depicts communications between the DSP sub-system, as shown in FIG. 3, and the main processor of the device in an example embodiment of the present invention.

### DETAILED DESCRIPTION OF THE INVENTION

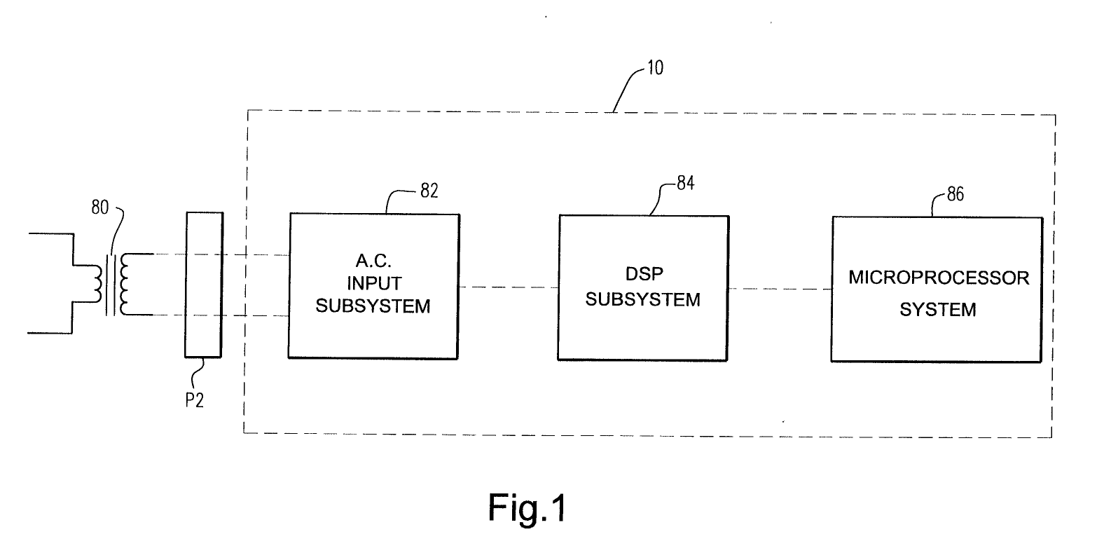

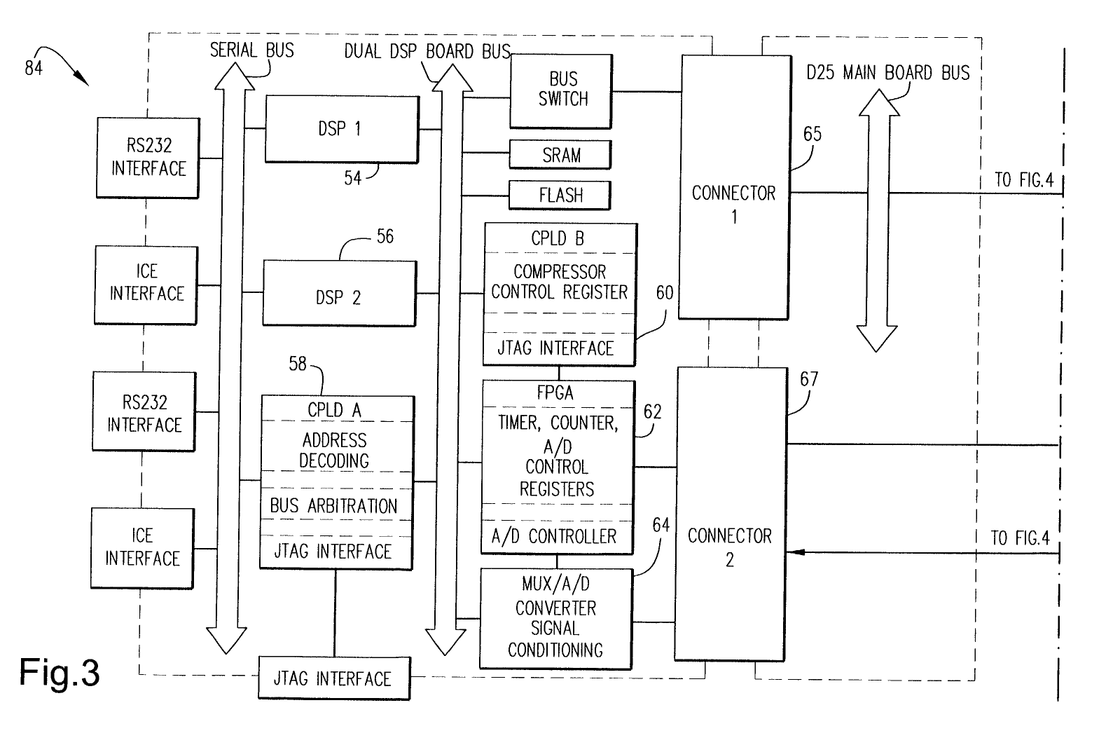

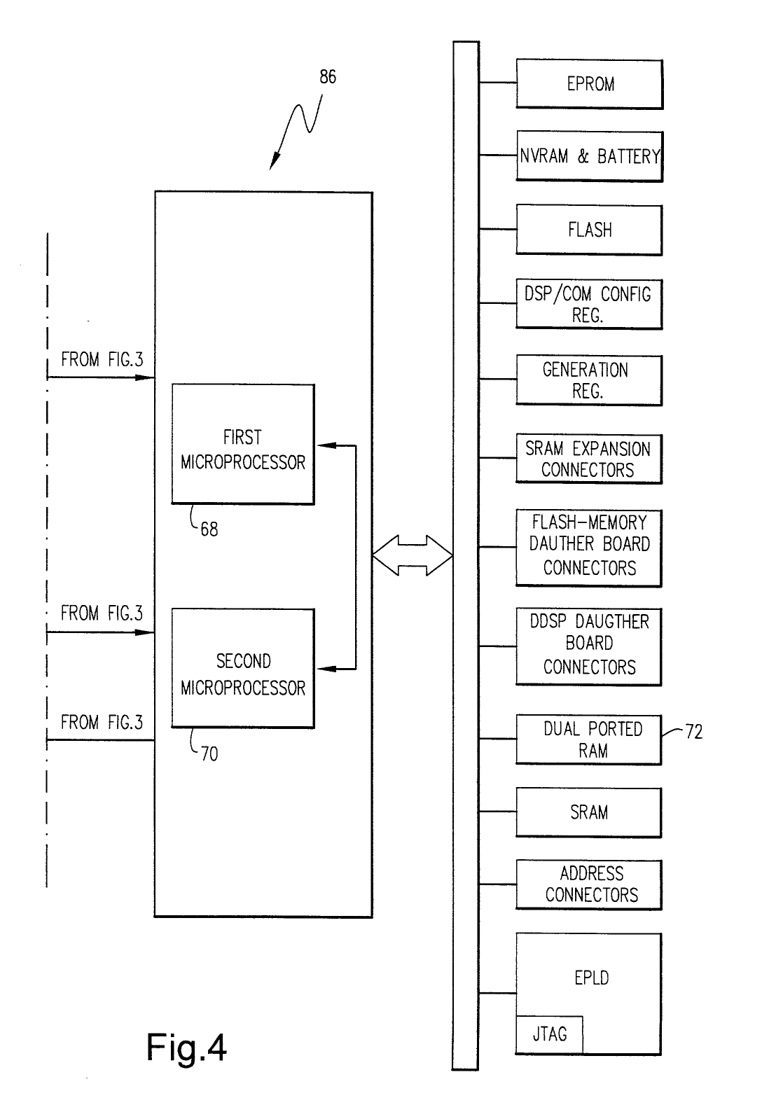

Referring now to FIG. 1, there is shown a high level block diagram of the IED according to the present invention. IED 10 generally includes an A.C. input subsystem 82, a digital signal processor (DSP) subsystem 84, and a microprocessor system 86. IED 10 is coupled to a field transformer 80 through a field interface terminal block P2. The field transformer 80 may be a current transformer (CT) or a potential transformer (PT). Input data from the field transformer 80 is received by an A.C. input sub-system 82 which is responsible for monitoring metering, power quality, and digital fault recording (DFR) functions. The DSP subsystem 84 includes first and second DSP devices 54, 56 (FIG. 3) one of the devices being responsible for metering and power quality signal from the A.C. subsystem 82 while the other is responsible for monitoring DFR functions. A microprocessor system 86 controls the overall operation of the IED device 10 including the functioning of the A.C. subsystem 82 and the DSP 84. The microprocessor system 86 includes microprocessors 68, 70 (FIG. 4). Microprocessor 70 operates under the control of microprocessor 68 to perform SCADA functions. It will be appreciated that the number of microprocessor used should not be limiting of the present invention. Greater or fewer number of processors may be used to accomplish the inventive functions.

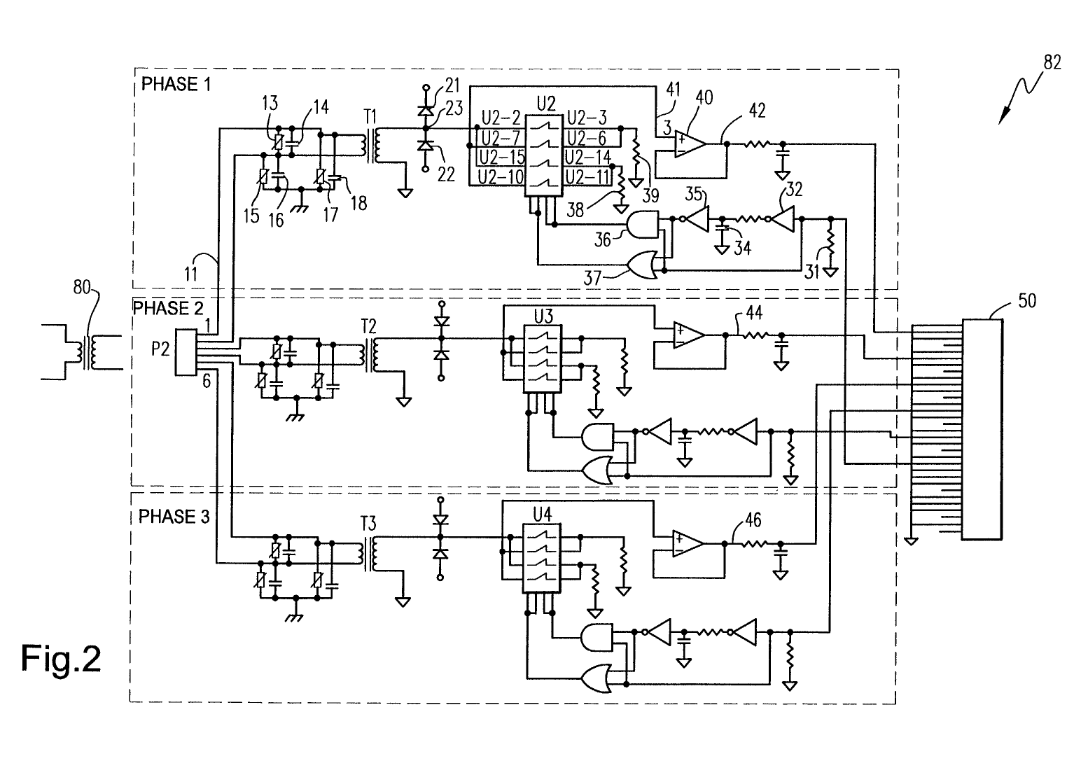

Referring now to FIG. 2, there is shown a detailed circuit diagram 82 of the A.C. input sub-system 82 of the multifunction IED 10. An input signal from a field transformer 80 is received in the terminal block P2 through the first terminal block position P2-1. The received signal enters conductor 11 and exits through the second terminal block position P2-2 where conductor 11 terminates. It should be noted that field transformer 80 need not necessarily be terminated at the terminal block P2, rather the connections from transformer 80 may pass through to the primary winding of transformer T1. Metal oxide varistor (MOV) 13, and capacitor 14 provide normal mode surge and fast transient protection to IED 10 from interference surges in respective phase of the power line. A circuit formed by MOVs 15, 17, and the capacitors 16, 18 provide common mode surge and impulse protection to circuit created by conductor 11. In the exemplary embodiment of FIG. 2, the A.C. input subsystem 82 is discussed with respect to three phases, generally identified as phase 1, phase 2, and phase 3, to explain the inventive concept without ambiguity. The present invention may actually be capable of operating on up to 12 phases of an electric circuit. It will further be appreciated that the present apparatus may be readily scaled to accommodate additional phases of an electric circuit.

Conductor 11 couples to the primary winding of transformer T1. Current in the primary winding of transformer T1 induces a magnetic field causing a signal to appear in the secondary winding. Supply voltages +V and −V are provided to diodes 21, 22, respectively. Diodes 21, 22 meet the second winding at junction 23 and provide crowbar protection against signals that are higher in positive and negative polarities than supply voltages +V and −V, respectively. A switching integrated circuit (SIC) U2 is connected to the secondary winding and controlled by DSP 84 (FIG. 3). DSP 84 is coupled to the AC subsystem 82 through an interface connector 50. DSP 84 is controlled by microprocessor 68 (FIG. 4). DSP 84 converts analog signals 42, 44, 46 to digital signals using a MUX/ A/D converter/signal conditioning unit (“MAS”) 64 (FIG. 3). The digital signals are then passed to DSP1 54 (FIG. 3) which then writes into a compressor register located in CPLD B 60 resulting in a control signal at device 32 of FIG. 2. The control signal at device 32 is high indicating compression mode when the analog signals 42, 44, 46 are in the overcurrent range. The control signal at device 32, however, is low when analog signals 42, 44, 46 are in the metering range. Other embodiments of the present invention may include switching to more than the described two positions depending on the interface to the DSP sub-system.

The SIC U2 having pins U2-10 & U2-11 and pins U2-14 & U2-15 engages resistance 38 into the circuit when the field current flowing through the primary winding of T1 is in the metering range, thereby developing a voltage at pin U2-10, the voltage being proportional to the current flowing in the primary winding of T1. When the field current flowing through the primary winding of T1 is in the overcurrent (DFR) range, resistance 39 is engaged by closing contacts U2-2 & U2-3, U2-6 & U2-7 and opening contacts U2-14 & U2-15, U2-10 & U2-11, thereby developing a voltage at pin U2-7, the voltage being proportional to the current flowing in the primary winding of transformer T1. The voltage developed at pin U2-7 or pin U2-10 of SIC U2 is now presented at pin 3 of the operational amplifier 40 which buffers the voltage to provide a signal identified at 42. The signal identified at 42 is multiplexed with similar signals identified at 44, 46 with respect to other phases of the power line. The multiplexed signals are converted to digital signals by MAS 64 of the DSP 84. Other embodiments of the present invention may include a single switching circuit for all of the transformers previously described.

The DSP 84 includes two digital signal processors (DSP1 54 & DSP2 56). DSP 84 further includes DSP I/O and DSP DFR, power quality and metering applications in software form. One of DSP1 54 or DSP2 56 may be dedicated to the collection of AC input data, while the other may be responsible for performing DFR functions. The DSP I/O application runs on DSP1 54 and receives sampled data from MAS 64, processes the received sampled data, and reports the processed data to processor 68 (FIG. 4) through a dual port memory 72 (FIG. 4). An interrupt routine running on DSP 84 receives samples from the MAS 64 and copies them to primary input buffers. Upon collecting data pertaining to a complete cycle, an interrupt routine of processor 68 sets a flag to initiate a main processing routine by correcting the magnitude component of the data using correction factors identified by a user via a user interface to offset manufacturing tolerances in transformer 80. The corrected data is then transformed into frequency domain applying a Discrete Fourier Transform (DFT). Phase correction is performed on the transformed data to compensate for the phase shift introduced by analog multiplexers of MAS 64. Total Harmonic Distortion (THD), Root-Mean Square (RMS) values for currents and voltages, active, reactive, and apparent power, power factor, energy values, and symmetrical components are then computed by DSP1 54, DSP2 56 under the control of processor 68. If 60/50 Hz filtering is enabled, then these values are computed using the fundamental frequency component only. However, if 60/50 Hz filtering is disabled, then these values are computed using all DFT series coefficients. The computed values are then copied into a dual-port memory 72 and an interrupt to processor 68 is issued. The sampling period is then adjusted and processing ceases until the interrupt routine sets the flag again, thus indicating that another cycle of data is ready for processing.

The DSP DFR application runs on DSP2 56 and receives sample data from the A/D converter of MAS 64. The DSP2 56 applies time stamps and reports the timestamps to processor 68 for further processing by the DFR Data Translation Application (DFR-DTA) residing in processor 68. The DSP-DFR application communicates with the DFR-DTA application through shared memory accessible to both the DSP DFR and processor 68 via the interprocessor communication subsystem (ICOM) software layer (not shown). ICOM includes a component resident in the code for processor 68 and a mirrored component resident in DSP2 56. The DSP DFR application functionalities includes boot and control of the DSP DFR processor in DSP2 56, providing communication functions with processor 68 (i.e., provide the DSP side of ICOM subsystem, now referred to as ICOM-DSP), providing communication functions with the DFR DTA application running on processor 68 according to the DFR DTA/DSP Message Protocol, reading data samples on the A.C. analog inputs and providing a time stamp to each of the analog inputs received by the A.C. subsystem 82, and transferring data samples to the shared memory to be available to the DFR DTA application. IED 10 is further capable of SCADA functions under the control of processor 70 (FIG. 4). Processor 70 communicates with processor 68 to distribute its data and to receive control operation commands. Thus, IED 10 of the present invention accomplishes metering, power quality, and DFR functions while maintaining SCADA functionality and performance.

The operation of the A.C. sub-system of the IED is explained with respect to a power line consisting of three phases as illustrated in FIG. 2. Circuit operation with respect to phase 1 is explained in detail as set forth above. Operation of phases 2 and 3 are similar to the operation of phase 1. The advantages of IED 10 include its ability to accurately report in the metering as well as overcurrent (DFR) ranges. Further, the IED 10 interfaces with all popular field transformers, has low input impedance, wide frequency response and operating temperature ranges. It is further immune to current overloads, and electromagnetic interference. The IED accomplishes high accuracy metering, power quality, and wide dynamic range DFR functions while maintaining SCADA functionality and performance.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A multifunction apparatus for monitoring and reporting electric signals on electric circuits, comprising:
a first system for receiving input data from at least a field transformer or a line post sensor;
a digital signal processor (DSP) system coupled to said first system;
a microprocessor system coupled to said DSP system; and
said first system in combination with said DSP system and said microprocessor system perform metering, power quality, digital fault recording (DFR) and supervisory control and data acquisition (SCADA) functions.

2. The apparatus of claim 1 wherein said first system comprises:
a plurality of transformers, each transformer operating with respect to one phase of an electric circuit; and
a plurality of switching circuits, each circuit coupled to a respective transformer and further adapted to switch to multiple positions depending on whether the current flowing through a primary circuit of a respective transformer is in a metering range or an overcurrent range.

3. The apparatus of claim 2 further comprises a circuit assembly for providing normal mode surge and fast transient protection.

4. The apparatus of claim 3 wherein said circuit assembly comprises a gas tube arrestor, a metal oxide varistor (MOV), a transient voltage suppressor, or a capacitor.

5. The apparatus of claim 2 further comprises a circuit assembly for providing common mode surge and transient protection.

6. The apparatus of claim 2 wherein a secondary circuit of each transformer includes a diode mirror circuit for providing crowbar protection against signals that are higher in absolute value than supply voltage.

7. A method for monitoring electric signals on electric circuits, said method comprising:
electrically coupling a monitoring apparatus to a field sensor;
feeding data from said field sensor to an A.C. subsystem of the monitoring apparatus, said A.C. subsystem comprising a plurality of transformers; and
causing switching circuits to switch to multiple positions depending on whether current flowing through a primary circuit of a respective transformer is in a metering range or an overcurrent range.

8. The method of claim 7 further comprises:
providing a digital signal processor (DSP) subsystem to process data received by said A.C. sub-system; and
providing one or more microprocessors for (a) controlling communication software applications of the apparatus, (b) performing supervisory control and data acquisition (SCADA) functions.

9. The method of claim 8 further comprises:
providing normal mode surge and transient protection circuit between the field sensor and a primary circuit of each of said plurality of transformers; and
controlling said A.C. sub-system and said DSP subsystem by said at least one or more microprocessors.

10. The method of claim 8 further comprises:
providing common mode surge and transient protection circuit between the field sensor and a primary circuit of each of said plurality of transformers.

11. The method of claim 9 further comprises:
providing a crowbar protection circuit against signals that are higher in absolute value than supply voltage.

12. The method of claim 11 wherein crowbar protection circuit comprises a diode mirror circuit.

13. A multifunction apparatus for monitoring and reporting electric signals, comprising:
a first subsystem receiving input data from at least one field sensor, said first subsystem having a plurality of transformers, one or more switching circuits, each switching circuit capable of switching to multiple positions depending on whether the current flowing in a primary circuit of a respective transformer is in a metering range or an overcurrent range;
one or more digital signal processors processing data received by said first subsystem; and
one or more microprocessors controlling said first subsystem and said one or more digital signal processors.

14. The apparatus of claim 13 further comprises a circuit assembly for providing normal mode surge and transient protection.

15. The apparatus of claim 14 wherein said circuit assembly comprises a metal oxide varistor (MOV), transient surge suppressor, gas tube arrestor, or a capacitor.

16. The apparatus of claim 15 wherein a secondary circuit of each transformer includes a diode mirror circuit for providing crowbar protection against signals that are higher in absolute value than supply voltage.

17. The apparatus of claim 13 further comprises:
a circuit assembly for providing common mode surge and transient protection.

18. An apparatus for monitoring electric signals on electric circuits, said apparatus comprising:
an A.C. sub-system having a plurality of transformers, and one or more switching circuits;
means for electrically coupling said apparatus to a field sensor;
means for feeding data from said field sensor to said A.C. subsystem; and
means for causing said switching circuits to switch to multiple positions depending on whether the current flowing in a primary circuit of a respective transformer is in a metering range or an overcurrent range.

19. The apparatus of claim 18 further comprises:
a digital signal processor (DSP) sub-system to process data received by said A.C. sub-system; and
one or more microprocessors for (a) controlling communication software applications of the apparatus, (b) performing supervisory control and data acquisition (SCADA) functions.

20. The apparatus as in claim 19 further comprises:
normal mode surge and transient protection circuit between the field sensor and a primary circuit of each transformer; and
means for controlling said A.C. sub-system and said DSP sub-system.

21. The apparatus as in claim 20 further comprises:
common mode surge and transient protection circuit between the field sensor and a primary circuit of each transformer.

22. The apparatus as in claim 21 further comprises:
means for protecting said apparatus against signals that are higher in absolute value than supply voltage.
